(19) United States
(12) Patent Application Publication
(10) Pub. No.: US 2026/0180108 A1
(43) Pub. Date: Jun. 25, 2026

(54) BATTERY PACK SYSTEM WITH SURFACE PRESSURE DISTRIBUTION STRUCTURE FOR BATTERY CELLS

(71) Applicants: Hyundai Motor Company, Seoul (KR); Kia Corporation, Seoul (KR)

(72) Inventors: Younghoo Oh, Hwaseong-si (KR); Junyoung Kang, Hwaseong-si (KR); Yoon Seok Eun, Hwaseong-si (KR)

(21) Appl. No.: 19/191,960

(22) Filed: Apr. 28, 2025

(30) Foreign Application Priority Data
Dec. 20, 2024 (KR) 10-2024-0192900

(51) Int. Cl. H01M 50/264; H01M 50/204; H01M 50/242

(52) U.S. Cl. CPC H01M 50/264; H01M 50/204; H01M 50/242

(57) ABSTRACT

A battery pack system features a base plate, transverse members, and at least three upward-extending longitudinal members that partition the base plate's surface into a lattice. Battery modules containing battery cells are installed in the resulting lattice-shaped spaces and coupled to seating portions at each intersection. Each longitudinal member includes a surface pressure block positioned between two fixing units, pushing the modules on both sides toward these fixing units for secure retention.

### CROSS-REFERENCE TO RELATED APPLICATIONS

This application is based on and claims the benefit of 35 U.S.C. 119 to Korean Patent Application No. 10-2024-0192900, filed on Dec. 20, 2024, in the Korean Intellectual Property Office, the disclosure of which is herein incorporated by reference in its entirety.

### TECHNICAL FIELD

The present disclosure relates to a battery pack system with a surface pressure distribution structure for battery cells, and more particularly to a battery pack system with a surface pressure distribution structure for battery cells capable of uniformly distributing the surface pressure applied to each battery cell, thereby providing more space in a battery pack and reducing a swelling phenomenon of each battery cell.

### BACKGROUND

Battery pack systems are widely used in various fields such as electric vehicles, energy storage systems (ESSs), and home appliances.

Generally, a plurality of battery cells is assembled in a stacked structure to form a battery module.

In order for battery cells disposed in a given space to be stably coupled to each other with maximum energy density, however, various kinds of information, such as thermal expansion between the battery cells, shock, and load, must be carefully analyzed and applied to the design.

Most battery cells are formed in the shape of a thin plate. In addition, the battery cell are stacked with wide surfaces facing each other to form a stacked structure.

In such a stacked structure, nonuniformly distributed surface pressure may lead to deformation of the battery cells, degradation of electrical properties, or short circuit between the battery cells.

In the course of designing battery pack systems, various attempts have been made to solve the above-mentioned problem related to surface pressure.

Nevertheless, conventional battery pack systems still lack the flexibility to predict and prevent various phenomena occurring among battery cells.

Therefore, it is necessary to propose technology capable of solving these problems.

### SUMMARY

It is an object of the present disclosure to solve a conventional problem that, when a plurality of battery modules is coupled to form a battery pack system, the magnitude and direction of the force applied to each battery module and each battery cell are not consistent.

It is another object of the present disclosure to solve a conventional problem that a plurality of battery modules coupled to a battery housing has a large deviation in the conditions given depending on the position thereof.

It is a further object of the present disclosure to solve a conventional problem that the area or width of a space in which the battery modules are seated is difficult to control although micro-deformation of a plurality of battery cells may be caused by swelling.

Objects of the present disclosure are not limited to the aforementioned objects, and other unmentioned objects of the present disclosure will be clearly understood from the following description.

A battery pack system according to an embodiment of the present disclosure includes a battery module, a base plate, a transverse member, a longitudinal member, and a seating portion. The battery module is configured to have a structure in which a plurality of battery cells is stacked. The base plate is a plate-shaped member, and a plurality of battery modules is installed on a wide upper surface of the base plate. A plurality of transverse members is provided on the upper surface of the base plate, is arranged parallel to each other, extends upward, and partitions the upper surface of the base plate. At least three longitudinal members are disposed on the upper surface of the base plate in a direction orthogonal to the transverse members, extend upward, and partition the upper surface of the base plate in a lattice shape. The battery modules are coupled respectively to seating portions, which constitute a lattice-shaped space formed by intersection of the transverse members and the longitudinal members. Each of the longitudinal members includes a pair of fixing units disposed on both side peripheries thereof, the pair of fixing units having highest structural rigidity among the transverse members and the longitudinal members, and a surface pressure block disposed between the pair of fixing units and configured to push the battery modules received on both sides toward the fixing units disposed on both sides, respectively.

In the battery pack system according to the embodiment of the present disclosure, each of the seating portions may be a space having a bottom surface formed by at least a part of the upper surface of the base plate and surrounded by a pair of transverse members parallel to each other and a pair of longitudinal members parallel to each other in a quadrangular shape.

Alternatively, in the battery pack system according to the embodiment of the present disclosure, the base plate may include a terminal module provided on one side of the base plate and a first side wall portion and a second side wall portion, which are walls disposed parallel to the longitudinal members and coupled to both side ends of the base plate, respectively.

In the battery pack system according to the embodiment of the present disclosure, the surface pressure block may further include a guide unit including an adhesive surface fixed to the upper surface of the base plate in an abutting state, a seating surface formed flat along the middle of an upper end thereof in a longitudinal direction, and a guide surface having a width gradually decreasing from the adhesive surface to the seating surface, and the surface pressure block may be detachably coupled to the seating surface of the guide unit.

Alternatively, in the battery pack system according to the embodiment of the present disclosure, the surface pressure block may include a center plane having a width equal to or greater than the width of the seating surface and in surface contact with the seating surface in a longitudinal direction, a pair of entry ends formed on both sides of the center plane so as to extend in the longitudinal direction of the center plane, each of the entry ends having an end protruding downward in a pointed manner, a pair of inner slopes, which are slopes configured to connect the pair of entry ends to both sides of the center plane, and a pair of outer slopes, which are slopes formed on sides of entry ends opposite the inner slopes.

In the battery pack system according to the embodiment of the present disclosure, the surface pressure block may include a pair of opposing walls formed on both sides of the center plane in the longitudinal direction of the center plane, which are walls extending upward from the pair of entry ends, and the surface pressure block, the entry ends, and the opposing walls may be integrally formed of a material undergoing low deformation under external load and having high rigidity.

Alternatively, in the battery pack system according to the embodiment of the present disclosure, the surface pressure block may include at least one reinforcing rib configured to connect the pair of opposing walls to each other in a longitudinal direction, the reinforcing rib being a thin plate-shaped member parallel to the center plane.

In the battery pack system according to the embodiment of the present disclosure, each of the opposing walls may include a protrusion protruding outward from the opposing wall along the position where the reinforcing rib is formed, the opposing wall having the same thickness as the reinforcing rib.

Alternatively, in the battery pack system according to the embodiment of the present disclosure, the seating surface may include a plurality of fastening holes formed at predetermined intervals in a longitudinal direction and a plurality of fastening pins coupled to the fastening holes, respectively, each of the fastening pins being made of a material undergoing large elastic deformation upon application of external force, the center plane may include a plurality of coupling holes formed at the positions corresponding to the fastening holes formed in the seating surface, and the battery pack system may further include a plurality of fastening members extending vertically in an upward-downward direction through the coupling holes, the fastening pins, and the coupling holes to fix the surface pressure block to the guide unit.

In the battery pack system according to the embodiment of the present disclosure, the battery module may include a back pad provided on the surface adjacent to the fixing unit or the surface pressure block and interposed between the fixing unit or the surface pressure block and the battery module, and the back pad may include an elastic layer made of an elastically deformable material, an inwardly facing surface formed on one surface of the elastic layer and having adhesion, and a lubrication side formed on the other surface of the elastic layer as a slippery surface.

### BRIEF DESCRIPTION OF THE DRAWINGS

FIG. 1 is a perspective view illustrating a battery housing in a battery pack system according to an embodiment of the present disclosure;

FIG. 2 is a perspective view illustrating that a battery module is coupled to a seating portion formed in the battery housing in the battery pack system according to the embodiment of the present disclosure;

FIG. 3 is a sectional view of the battery pack system according to the embodiment of the present disclosure, taken along an X-Y plane;

FIG. 4 is a partial enlarged view showing a part labeled A in FIG. 3;

FIG. 5 is a partial enlarged view showing a middle part of FIG. 3;

FIG. 6 is a view showing the shape of one of longitudinal members to which a guide unit and a surface pressure block are coupled in the battery pack system according to the embodiment of the present disclosure;

FIG. 7 is a partial perspective view illustrating the structure of the surface pressure block in the battery pack system according to the embodiment of the present disclosure;

FIG. 8 is a schematic view showing the coupling relationship between the guide unit and the surface pressure block in the battery pack system according to the embodiment of the present disclosure;

FIG. 9 is a schematic view showing the coupling relationship between a guide unit and a surface pressure block in a battery pack system according to another embodiment of the present disclosure; and

FIG. 10 is a view showing the sectional structure of one of longitudinal members formed as a fixing unit in the battery pack system according to the embodiment of the present disclosure.

### DETAILED DESCRIPTION OF ILLUSTRATIVE EMBODIMENTS

Hereinafter, embodiments disclosed herein will be described in detail with reference to the accompanying drawings.

Identical or similar components are denoted by identical or similar reference numerals, and redundant descriptions may be omitted.

When a component is referred to as being “connected” or “coupled” to another component, the component may be directly connected or coupled to the other component or there may be other components therebetween.

On the other hand, when a component is referred to as being “directly connected” or “directly coupled” to another component, it is meant that there is no other component therebetween.

In this specification, the term “including” or “having” indicates the presence of the features, steps, operations, components, parts, or combinations thereof described herein, without excluding any one thereof.

A first direction (X-axis direction), a second direction (Y-axis direction), and a third direction (Z-axis direction) described herein are used to describe a solid shape in a three-dimensional space, and are orthogonal to each other.

The present disclosure is configured to improve the performance and stability of a battery pack system by stably supporting a battery module 1 including a plurality of battery cells and uniformly distributing the surface pressure applied to the battery modules 1 or battery cells.

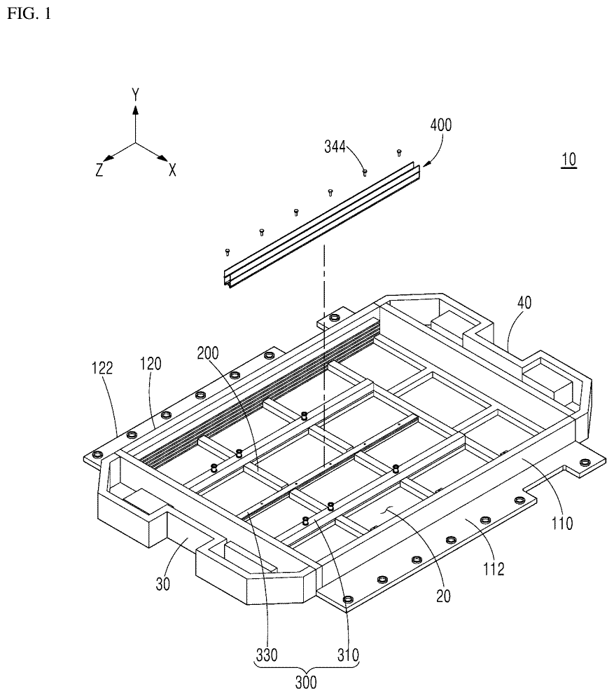

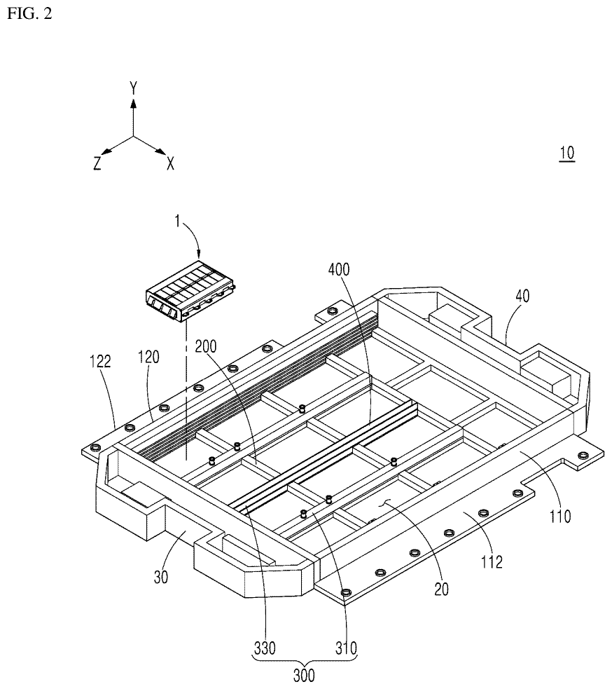

FIG. 1 is a perspective view illustrating a battery housing 10 in a battery pack system according to an embodiment of the present disclosure, and FIG. 2 is a perspective view illustrating that a battery module 1 is coupled to a seating portion 20 formed in the battery housing 10 in the battery pack system according to the embodiment of the present disclosure.

As shown in FIGS. 1 and 2, a battery pack system with a surface pressure distributed structure for battery cells according to an embodiment of the present disclosure includes a battery housing 10 to which a plurality of battery modules 1 may be coupled.

The battery housing 10 is configured such that the battery modules 1 are installed in predetermined space with high energy density.

Accordingly, the battery housing 10 often has therein predetermined positions where the battery modules 1 are coupled.

First, the battery module 1 includes a plurality of battery cells. The battery cells, each of which is generally a flat, plate-shaped structure, overlap each other so as to be coupled in a stacked structure.

The battery cells thus coupled in the stacked structure form a single battery module 1.

The plurality of battery modules 1 are coupled at predetermined positions in the battery housing 10.

The battery housing 10 includes a base plate 100 corresponding to a bottom surface, a first side wall portion 110 and a second side wall portion 120 forming both side wall surfaces and removably attached to the base plate 100.

The first side wall portion 110 and the second side wall portion 120 may further include a first installation end 112 and/or a second installation end 122 extending outward for connection or coupling to an external device, a structure, or components constituting the battery pack system.

In addition, a power line, a data cable, a refrigerant, or an air hose may be installed on the side of the battery housing 10 in a +Z-axis direction as needed, and will be referred to as a terminal module 30 for ease of identification.

The battery housing 10 has a plurality of seating portions 20 formed on an upper part of the base plate 100, i.e., on an upper surface of the base plate 100, in order to efficiently distribute space such that as many battery modules 1 as possible can be coupled.

The seating portions 20 are predetermined spaces formed when a plurality of transverse members 200 and a plurality of longitudinal members 300 are disposed straight in predetermined directions and intersect each other.

In the battery pack system according to the embodiment of the present disclosure, the transverse member 200 is provided in plural. The plurality of transverse members 200 is provided on the upper surface of the base plate 100 and is formed along straight paths arranged parallel to each other. The plurality of transverse members 200 is provided on the upper surface of the base plate 100 in parallel to each other, as shown.

Each of the transverse members 200 protrudes upward from the upper surface of the base plate 100 by a predetermined height.

The transverse members 200 may be implemented as walls, partitions, end jaws, or the like that protrude from the upper surface of the base plate 100, and the transverse members 200 partition the upper surface of the base plate 100.

In the embodiment of the present disclosure, at least three longitudinal members 300 may be provided. However, the number of longitudinal members 300 is not limited to three.

Depending on embodiments through which the present disclosure is implemented, the number of longitudinal members 300 provided on the upper surface of the base plate 100 may be 3, 7, 11, 15, or 19.

The reason that the number of the longitudinal members 300 is proposed as described above is that, when a surface pressure block 400 configured to apply surface pressure to the battery modules 1 located on both sides in opposite directions is disposed at a middle one of the longitudinal members 300 disposed in parallel, the efficiency is improved.

As will be described later, the longitudinal member 300 may be divided into a fixing unit 310 and a surface pressure block 400.

The fixing unit 310 is a longitudinal member 300 that is rigidly installed and formed to support external force.

On the other hand, the surface pressure block 400 is a longitudinal member 300 that distributes the surface pressure to the battery modules 1 located on both sides.

Therefore, it is preferable for at least three longitudinal members 300 to be provided.

The longitudinal member 300 disposed in the middle is the surface pressure block 400 and the fixing units 310 are disposed on both sides of the surface pressure block 400, which is advantageous for distributing the surface pressure applied to the interior of the battery housing 10 in the battery pack system according to the embodiment of the present disclosure.

Referring to the figures, in the battery pack system according to the embodiment of the present disclosure, the longitudinal member 300 may be divided into a fixing unit 310 and a surface pressure block 400.

When the number of longitudinal members 300 is three, for example, a middle one of the three longitudinal members 300 is provided as the surface pressure block 400.

The two longitudinal members 300 disposed on both sides of the surface pressure block 400 in parallel are provided as the fixing units 310.

First, the fixing unit 310, which may be made of a material having high rigidity, is securely fixed or coupled to the base plate 100.

The fixing unit 310 must be made of the most rigid material among the surrounding components, such as the plurality of transverse members 200 and the plurality of longitudinal members 300 provided in the battery housing 10.

The fixing unit 310 may have a fixing surface 312 formed on an upper end thereof, and is constituted by a wall extending along an imaginary straight line parallel to the Z-axis while having a predetermined width.

Both side wall surfaces of the fixing unit 310 may be covered to a predetermined thickness with a dissimilar material to increase strength. The two long opposing side surfaces of the fixing unit 310 form a load-bearing wall 314. The load-bearing wall 314 is designed to be rigid to resist transverse force.

The surface pressure block 400 may be detachably coupled to the upper surface of the base plate 100.

Specifically, referring to the figures, a middle one of the longitudinal members 300 installed on the upper surface of the base plate 100 in parallel may include a guide unit 330 and a surface pressure block 400.

The guide unit 330 is fixed to an upper surface of the base plate 100. The guide unit 330 includes an adhesive surface 336. The adhesive surface 336 is coupled to the upper surface of the base plate 100 in contact therewith, and is formed on a lower surface of the guide unit 330.

The adhesive surface 336 has a constant width and extends in a straight direction parallel to the longitudinal members 300 therearound.

A central part of an upper end of the guide unit 330 has a seating surface 332, which is a flat surface formed in a longitudinal direction. The seating surface 332 is opposite the adhesive surface 336, and is disposed directly above the adhesive surface 336 along the path along which the adhesive surface 336 is formed.

The width of the seating surface 332 is less than the width of the adhesive surface 336.

The width between both sides of the guide unit 330 gradually decreases from the adhesive surface 336 on the lower end thereof to the seating surface 332 on the upper end thereof. That is, both sides of the guide unit 330 are formed as guide surfaces 334 that are inwardly inclined in the upward direction.

A pair of entry ends 420 formed on the lower end of the surface pressure block 400 abuts the guide surfaces 334 on both sides of the guide unit 330, and the seating surface 332 on the upper end of the guide unit 330 and a center plane 410 on a lower end of the surface pressure block 400 are joined to each other at a predetermined position and aligned with each other.

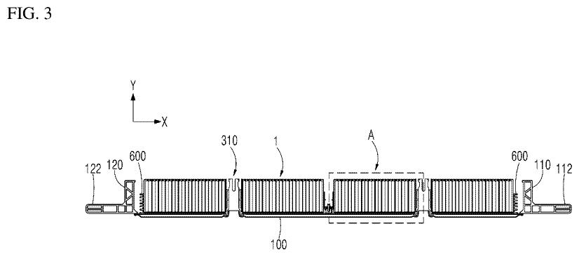

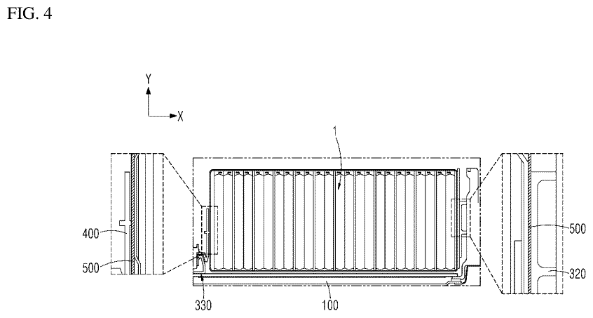

FIG. 3 is a sectional view of the battery pack system according to the embodiment of the present disclosure, taken along an X-Y plane, and FIG. 4 is a partial enlarged view showing a part labeled A in FIG. 3.

As shown in FIGS. 3 and 4, the battery housing 10 includes a base plate 100 forming a bottom surface parallel to the X-Z plane therein. The plurality of transverse members 200 and the plurality of longitudinal members 300 are disposed on a wide upper surface of the base plate 100 in a predetermined shape.

Referring to FIG. 3, the plurality of transverse members 200 is formed on the upper surface of the base plate 100 in a straight path parallel to the X-axis.

The plurality of longitudinal members 300 is formed on the upper surface of the base plate 100 in a straight path parallel to the Z-axis.

The battery pack system according to the embodiment of the present disclosure may further include a first side wall portion 110 and a second side wall portion 120, which are side walls formed in a direction parallel to the longitudinal members 300 along both edges of the base plate 100.

Most of the upper surface of the base plate 100 is provided with a plurality of seating portions 20, in each of which a battery module 1 is mounted. The plurality of seating portions 20 is designed to maximize the efficiency of the plurality of battery modules 1 and various components, such as a short circuit module and a cooling module.

The battery pack system according to the embodiment of the present disclosure is characterized in that each of the plurality of longitudinal members 300 is divided into a fixing unit 310 and a surface pressure block 400.

Referring to the figures, when the number of longitudinal members 300 is three in the present disclosure, a middle one of the longitudinal members 300 is provided as the surface pressure block 400, and the two longitudinal members 300 disposed on both sides of the surface pressure block 400 are provided as the fixing units 310.

The seating portion 20 on which each battery module 1 is mounted is formed as a space having four sides surrounded by a pair of parallel longitudinal members 300 and a pair of parallel transverse members 200.

Each of the seating members 20 has a bottom surface formed by a part of the upper surface of the base plate 100.

The battery housing 10 may be provided with a plurality of seating portions 20. In the embodiment of the present disclosure, the seating portions 20 are constituted by a plurality of spaces formed on the base plate 100 in a lattice-shaped pattern.

The battery modules 1 are received in the seating portions 20, respectively, to form the battery pack system.

As shown, a pair of end-plates 600 configured to fix the battery modules 1 mounted in the plurality of seating portions 20 on both sides may be provided inside the first side wall portion 110 and the second side wall portion 120, respectively.

As shown in FIGS. 3 and 4, the surface pressure block 400 is installed the upper surface of the base plate 100 across the center thereof in the Z-axis direction.

A pair of fixing units 310 disposed parallel to each other is disposed on both sides of the surface pressure block 400, and the seating portion 20 is formed between each side of the surface pressure block 400 and the load-bearing wall 314 of each of the fixing units 310 facing inward such that the battery module 1 is mounted therein.

Each battery module 1 is mounted in a corresponding one of the seating portions 20 in consideration of the direction of the contact surfaces of the battery cells arranged in the stacked structure therein.

As shown in FIG. 1, the seating portion 20 is formed between the surface pressure block 400 and the fixing unit 310, and the battery module 1 is coupled to the seating portion 20.

In this case, the battery module 1 is installed such that one surface of the battery module 1 faces the load-bearing wall 314 on one side of the fixing unit 310 having the high structural rigidity and the other surface of the battery module 1 faces the surface pressure block 400 located in the middle.

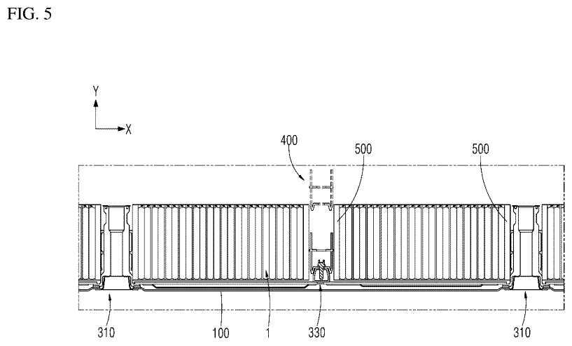

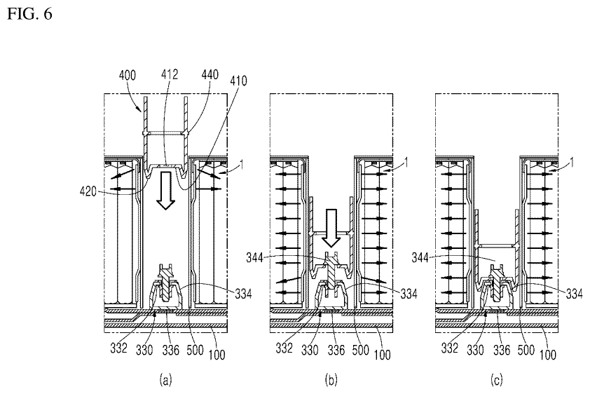

FIG. 5 is a partial enlarged view showing a middle part of FIG. 3, and FIG. 6 is a view showing the shape of one of the longitudinal members 300 to which the guide unit 330 and the surface pressure block 400 are coupled in the battery pack system according to the embodiment of the present disclosure.

As shown in FIGS. 5 and 6, the battery modules 1 may be coupled to the respective seating portions 20 in a pre-assembly process in which one surface of each battery module 1 is lightly pressed against the load-bearing walls 314 on both sides of the fixing unit 310.

While one surface of the battery module 1 may be in direct contact with the load-bearing wall 314 facing the battery module, a back pad 500 is interposed between the surface of the battery module 1 and the load-bearing wall 314 in the battery pack system according to the embodiment of the present disclosure. Similarly, the back pad 500 may also be interposed between the surface of the battery module 1 and an opposing wall 430 of the surface pressure block 400.

Each of the back pads 500 is formed so as to correspond to the area of each of two opposing side surfaces of each battery module 1, and is formed as a thin pad to induce predetermined buffering and force distribution.

The back pad 500 includes an elastic layer 520 made of a highly resilient material and forming a middle layer.

One surface of the elastic layer 520 may be provided with an inwardly facing surface 510, which is a surface layer having adhesion or a high coefficient of friction. In addition, the other surface of the elastic layer 520, which is the surface facing the side opposite the inwardly facing surface 510, may be provided with a lubrication surface 530 having a low coefficient of friction and configured to slide easily.

When each battery module 1 comes into contact with a structure in the battery housing, the back pad 500 may be interposed therebetween. The inwardly facing surface 510 of the back pad 500 is necessarily disposed abutting the surface of the battery module 1, and the opposite lubrication surface 530 faces outwardly of the battery module 1.

In addition, a contact plate 320 may be further interposed between one surface of each battery module 1 and the load-bearing wall 314 of the fixing unit 310 facing the same, in addition to the back pad 500.

The contact plate 320 is disposed between the lubrication surface 530 of the back pad 500 and the surface of the load-bearing wall 314, and is formed such that the force applied in a leftward-rightward direction is not concentrated but is distributed in a plane direction corresponding to the surfaces abutting each other.

After the pre-assembly process described above, a post-assembly process may be performed. The post-assembly process includes inserting the surface pressure block 400 between the battery modules 1 seated in the seating portions 20 on both sides of the guide unit 330 in a pre-assembled state in a downward direction from above.

The surface pressure block 400 is provided on a lower end thereof with a center plane 410, which is a downwardly facing surface, and entry ends 420 protruding downward in a pointed manner are provided on both sides of the center plane 410.

The surface pressure block 400 includes two opposing walls 430, which are side wall structures extending upward from the entry ends 420 and formed long on both sides of the surface pressure block 400 in the longitudinal direction.

The surface pressure block 400 may be made of a material having high rigidity and may be one in number.

The center plane 410 has a width at least equal to or greater than the width of the seating surface 332 formed on the upper surface of the guide unit 330. A pair of entry ends 420 extending in the Z-axis direction is formed on both corner portions of the center plane 410. Each entry end 420 has a protruding structure with an end protruding downward in a pointed manner.

Each of the entry ends 420 may include an inner slope 422 facing inward toward the center plane 410 and an outer slope 424 opposite the inner slope 422 and sloping outward from a lower end of the entry end 420, and a pair of opposing walls 430 may be formed as two wall structures extending upward from the outer slopes 424 formed on the entry ends 420.

The lower end of the surface pressure block 400 on which the center plane 410 and the entry ends 420 are formed is introduced between the battery modules 1 located in the seating portions 20 on both sides thereof in a pre-assembled state. The pair of opposing walls 430 formed on both sides of the surface pressure block 400 presses the surfaces of the battery modules 1 adjacent thereto outward.

The surface pressure block 400 is fitted between the battery modules 1 in the upward-downward direction such that the inner slopes 422 of the entry ends 420 formed at the lowest end thereof abut the guide surfaces 334 of the guide unit 330.

As a result, the center plane 410 and the seating surface 332 may be aligned such that the center plane and the seating surface 332 abut each other within a predetermined range.

The surface pressure block 400 may further include reinforcing ribs 440 on a pair of opposing walls 430 provided on both sides thereof to apply surface pressure to the surfaces of the battery modules 1 disposed on both sides thereof.

The reinforcing rib 440 may be a thin plate-shape member formed parallel to the center plane 410.

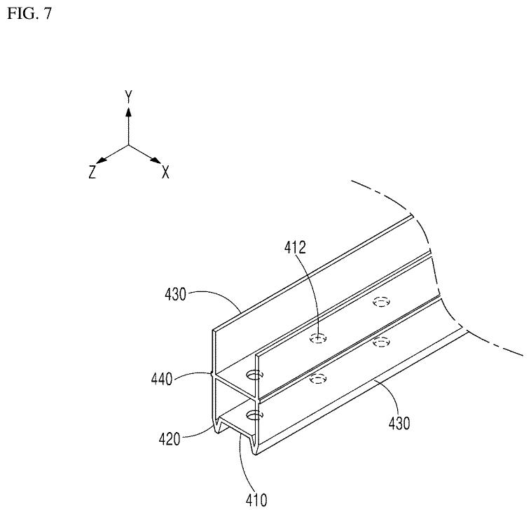

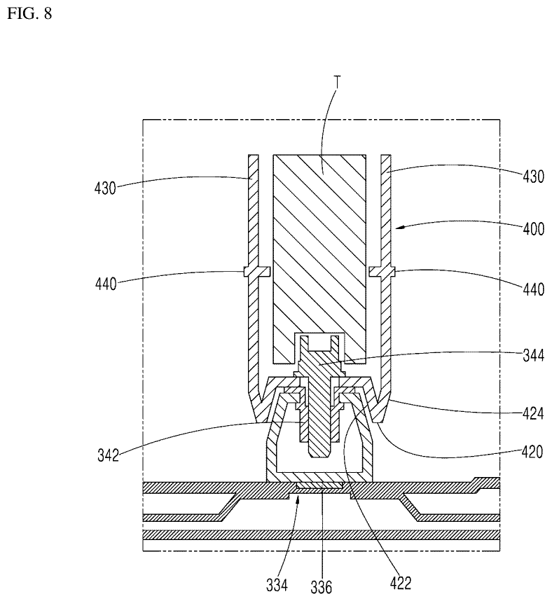

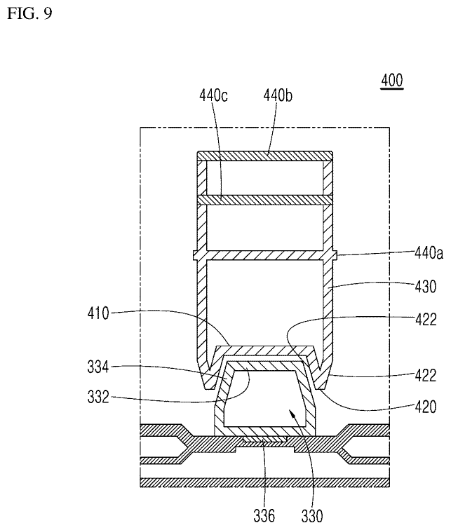

FIG. 7 is a partial perspective view illustrating the structure of the surface pressure block 400 in the battery pack system according to the embodiment of the present disclosure, FIG. 8 is a schematic view showing the coupling relationship between the guide unit 330 and the surface pressure block 400 in the battery pack system according to the embodiment of the present disclosure, and FIG. 9 is a schematic view showing the coupling relationship between a guide unit 330 and a surface pressure block 400 in a battery pack system according to another embodiment of the present disclosure.

As shown, the reinforcing rib 440 is formed in the space between the opposing walls 430 and connects facing surfaces of the opposing walls 430 to each other. A plurality of reinforcing ribs 440 may be disposed horizontally at predetermined vertical intervals.

The surface pressure block 400 and the guide unit 330 may be fixed by the pushing force of the load-bearing walls 314 from both sides in the state in which the center plane 410 and the seating surface 332 abut each other and counterforce corresponding thereto. However, a fastening pin 342 and a fastening member 344 may be further provided such that the surface pressure block 400 and the guide unit 330 can be more securely fastened to each other.

The seating surface 332 of the guide unit 330 may have a plurality of fastening holes 340 formed at predetermined intervals in the longitudinal direction.

The fastening pin 342, which is made of a highly elastic material, may be mounted in each of the fastening holes 340. When a part of a lower end of the fastening member 344 is introduced into the fastening hole 340, the fastening pin 342 is elastically deformed to more securely couple the fastening member 344 to the fastening hole 340.

A plurality of coupling holes 412 corresponding to the fastening holes 340 formed in the seating surface 332 is formed in the center plane 410 of the surface pressure block 400. When at least one reinforcing rib 440 is provided on the surface pressure block 400 in accordance with an embodiment of the present disclosure, each of the reinforcing ribs 440 may also have a coupling hole 412 formed directly above the coupling holes 412 formed in the center plane 410. The fastening member 344 may extend vertically through the coupling hole 412 formed in the reinforcing rib 440 in the downward direction, and a tool T for fastening the fastening member 344 may be moved in the upward-downward direction.

As shown in FIGS. 8 and 9, each of the pair of opposing walls 430 provided at the surface pressure block 400 may further be provided with a protrusion extending from an outwardly facing outer surface thereof in the transverse direction. The protrusion may be provided on an outer surface of each of the opposing walls 430 along the position where the reinforcing rib 440 is connected perpendicularly to an inner surface of each of the opposing walls 430 when the reinforcing rib 440 is formed between the pair of opposing walls 430.

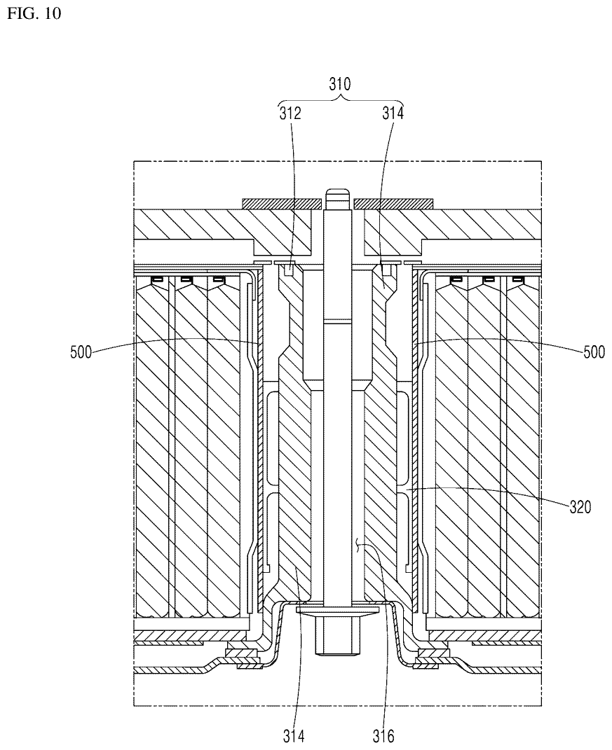

FIG. 10 is a view showing the sectional structure of one of the longitudinal members 300 formed as the fixing unit 310 in the battery pack system according to the embodiment of the present disclosure.

As shown in FIG. 10, in the battery pack system according to the embodiment of the present disclosure, the fixing unit 310, which is one of the longitudinal members 300, may have expansion coupling holes 412 and 316 configured to form higher resistance to external force in the transverse direction between the load-bearing walls 314 on both sides. Each of the expansion coupling holes 412 and 316 is a passageway with a circular section formed in the vertical direction. The tool T or fastening members may pass through the expansion coupling holes 412 and 316, which further increase the structural rigidity of the load-bearing walls 314 on both sides of the fixing unit 310 due to the circular section thereof.

The present disclosure has the effect of making a process of assembling a plurality of battery modules in a battery housing more regular and simplified, thereby more quickly and easily manufacturing a battery pack system.

The present disclosure has the effect that the plurality of battery modules coupled to the battery housing has small deviation in given conditions even if the coupling positions thereof are different.

The present disclosure has the effect that a large number of battery modules can be assembled flexibly even if the size or volume of each battery module varies within a tolerance range in a regular seating and coupling process.

The present disclosure has the effect of making each battery cell, battery module, and battery pack system more stable and robust by ensuring that the surface pressure applied to each of the battery modules that are to be densely disposed in a defined space is uniformly distributed.

Effects of the present disclosure are not limited to the aforementioned effects, and other unmentioned effects of the present disclosure will be clearly understood by those skilled in the art from the above description.

Embodiments of the present disclosure have been described above with reference to the drawings. The described embodiments and the drawings are given by way of example, and it is obvious that the present disclosure can be variously modified within the scope of the disclosed technical ideas.

The described embodiments are to be considered as part of the present disclosure, and the scope of the present disclosure is not limited to the described embodiments.

The scope of the present disclosure is to be determined by the technical ideas recited in the claims.

Even if the described embodiments do not explicitly describe the operation or effect of a specific construction, the operation or effect that can be predicted by the construction is within the scope of the present disclosure.

What is claimed is:

1. A battery pack system with a surface pressure distribution structure for battery cells, the battery pack system comprising:
a battery module comprising a plurality of battery cells coupled in a stacked structure;
a base plate, which is a plate-shaped member, configured to allow a plurality of battery modules to be installed on a wide upper surface thereof;
a plurality of transverse members provided on the wide upper surface of the base plate, arranged parallel to each other, extending upward, and configured to partition the wide upper surface of the base plate;
at least three longitudinal members disposed on the wide upper surface of the base plate in a direction orthogonal to the plurality of transverse members, extending upward, and configured to partition the wide upper surface of the base plate in a lattice shape; and
a plurality of seating portions, each of which is a lattice-shaped space formed by intersection of the transverse members and the longitudinal members, and is configured to allow the battery modules to be coupled thereto,
wherein the at least three longitudinal members comprise:
a pair of fixing units disposed on both side peripheries thereof, the pair of fixing units having highest structural rigidity among the transverse members and the longitudinal members; and
a surface pressure block disposed between the pair of fixing units and configured to push the plurality of battery modules received on both sides toward the fixing units disposed on both sides, respectively.

2. The battery pack system according to claim 1, wherein each of the plurality of seating portions is a space having a bottom surface formed by at least a part of the wide upper surface of the base plate and surrounded by a pair of transverse members parallel to each other and a pair of longitudinal members parallel to each other in a quadrangular shape.

3. The battery pack system according to claim 1, wherein the base plate comprises:
a terminal module provided on one side of the base plate; and
a first side wall portion and a second side wall portion disposed parallel to the longitudinal members and coupled to both side ends of the base plate, respectively.

4. The battery pack system according to claim 1, wherein:
the surface pressure block further comprises:
a guide unit comprising an adhesive surface fixed to the wide upper surface of the base plate in an abutting state;
a seating surface formed flat along a middle of an upper end of the guide unit in a longitudinal direction; and
a guide surface having a width gradually decreasing from the adhesive surface to the seating surface, and
the surface pressure block is detachably coupled to the seating surface of the guide unit.

5. The battery pack system according to claim 4, wherein the surface pressure block further comprises:
a center plane having a width equal to or greater than a width of the seating surface and in surface contact with the seating surface in the longitudinal direction;
a pair of entry ends formed on both sides of the center plane so as to extend in the longitudinal direction of the center plane, each of the entry ends having an end protruding downward in a pointed manner;
a pair of inner slopes configured to connect the pair of entry ends to both sides of the center plane; and
a pair of outer slopes formed on sides of entry ends opposite the inner slopes.

6. The battery pack system according to claim 5, wherein:
the surface pressure block further comprises a pair of opposing walls formed on both sides of the center plane in the longitudinal direction of the center plane and extending upward from the pair of entry ends, and
the surface pressure block, the entry ends, and the opposing walls are integrally formed of a material.

7. The battery pack system according to claim 6, wherein the surface pressure block further comprises at least one reinforcing rib configured to connect the pair of opposing walls to each other in the longitudinal direction, the reinforcing rib being a thin plate-shaped member parallel to the center plane.

8. The battery pack system according to claim 7, wherein each of the opposing walls comprises a protrusion protruding outward from the opposing wall along a position where the reinforcing rib is formed, the opposing wall having the same thickness as the reinforcing rib.

9. The battery pack system according to claim 5, wherein:
the seating surface comprises:
a plurality of fastening holes formed at predetermined intervals in the longitudinal direction; and
a plurality of fastening pins coupled to the fastening holes, respectively, each of the fastening pins being made of a material undergoing elastic deformation upon application of external force,
the center plane comprises a plurality of coupling holes formed at positions corresponding to the fastening holes formed in the seating surface, and
the battery pack system further comprises a plurality of fastening members extending vertically in an upward-downward direction through the coupling holes, the fastening pins, and the coupling holes to fix the surface pressure block to the guide unit.

10. The battery pack system according to claim 1, wherein:
the battery module comprises a back pad provided on a surface adjacent to the fixing unit or the surface pressure block and interposed between the fixing unit or the surface pressure block and the battery module, and
the back pad comprises:
an elastic layer made of an elastically deformable material;
an inwardly facing surface formed on one surface of the elastic layer and having adhesion; and
a lubrication side formed on the other surface of the elastic layer as a slippery surface.

11. A battery pack system with a surface pressure distribution structure for battery cells, the battery pack system comprising:
a base plate comprising an upper surface;
a plurality of transverse members provided on the upper surface, arranged parallel to each other, and extending upward;
a plurality of longitudinal members disposed on the upper surface in a direction orthogonal to the plurality of transverse members and extending upward; and
a plurality of seating portions formed by intersections of the plurality of transverse members and the plurality of longitudinal members and configured to receive a plurality of battery modules,
wherein the plurality of longitudinal members comprises:
a pair of fixing units, the pair of fixing units having highest structural rigidity among the plurality of transverse members and the plurality of longitudinal members; and
a surface pressure block disposed between the pair of fixing units and configured to push the plurality of battery modules toward at least one of the pair of fixing units.

12. The battery pack system of claim 11, wherein:
each of the plurality of seating portions comprises a bottom surface formed by at least a part of the upper surface of the base plate, and
each of the plurality of seating portions is surrounded by two transverse members of the plurality of transverse members and two longitudinal members of the plurality of longitudinal members to form a quadrangular shape.

13. The battery pack system of claim 11, wherein the base plate further comprises:
a terminal module provided on a side of the base plate;
a first side wall portion; and
a second side wall portion,
wherein the first side wall portion and the second side wall portion are disposed parallel to the plurality of longitudinal members and coupled to both side ends of the base plate, respectively.

14. The battery pack system of claim 11, wherein:
the surface pressure block comprises:
a guide unit comprising an adhesive surface fixed to the upper surface of the base plate in an abutting state;
a seating surface formed flat along a middle of an upper end of the guide unit in a longitudinal direction; and
a guide surface having a width that decreases from the adhesive surface to the seating surface, and
the surface pressure block is detachably coupled to the seating surface of the guide unit.

15. The battery pack system of claim 14, wherein the surface pressure block further comprises:
a center plane having a width equal to or greater than a width of the seating surface and in surface contact with the seating surface in the longitudinal direction;
a pair of entry ends formed on both sides of the center plane and extending in the longitudinal direction of the center plane, each of the entry ends having an end protruding downward;
a pair of inner slopes configured to connect the pair of entry ends to both sides of the center plane; and
a pair of outer slopes formed on sides of entry ends opposite the inner slopes.

16. The battery pack system of claim 15, wherein:
the surface pressure block further comprises a pair of opposing walls formed on both sides of the center plane in the longitudinal direction of the center plane and extending upward from the pair of entry ends, and
the surface pressure block, the entry ends, and the opposing walls are integrally formed of a material.

17. The battery pack system according to claim 16, wherein the surface pressure block further comprises at least one reinforcing rib configured to connect the pair of opposing walls to each other in the longitudinal direction, the reinforcing rib being a thin plate-shaped member parallel to the center plane.

18. The battery pack system according to claim 17, wherein each of the opposing walls comprises a protrusion protruding outward from the opposing wall along a position where the reinforcing rib is formed, the opposing wall having the same thickness as the reinforcing rib.

19. The battery pack system of claim 15, wherein:
the seating surface comprises:
a plurality of fastening holes formed at predetermined intervals in the longitudinal direction; and
a plurality of fastening pins coupled to the fastening holes, respectively, each of the fastening pins being made of a material undergoing elastic deformation upon application of external force,
the center plane comprises a plurality of coupling holes formed at positions corresponding to the fastening holes formed in the seating surface, and
the battery pack system further comprises a plurality of fastening members extending through the coupling holes, the fastening pins, and the coupling holes to fix the surface pressure block to the guide unit.

20. A battery housing, comprising:
a base plate;
a plurality of transverse members on an upper surface of the based plate and parallel to each other;
two longitudinal fixing members disposed on the upper surface of the base plate and orthogonal to the plurality of transverse members; and
a surface pressure block between and parallel to the two longitudinal fixing members and configured to push a plurality of battery modules towards at least one of the two longitudinal fixing members.
